(19) United States
(12) Patent Application Publication
(10) Pub. No.: US 2024/0212041 A1
(43) Pub. Date: Jun. 27, 2024

(54) AUTOMATIC DATA SEGMENTATION SYSTEM

(71) Applicant: Experian Health, Inc., Franklin, TN (US)

(72) Inventors: Christopher G. Busch, Maple Grove, MN (US); Nathaniel W. Lutz, Apple Valley, MN (US); Zackary Dixon, Leander, TX (US)

(21) Appl. No.: 18/527,040

(22) Filed: Dec. 1, 2023

Related U.S. Application Data
(63) Continuation of application No. 16/521,267, filed on Jul. 24, 2019, now abandoned.
(60) Provisional application No. 62/702,646, filed on Jul. 24, 2018.

(51) Int. Cl. G06Q 40/03; G06F 16/28; G06N 20/00

(52) U.S. Cl. CPC G06Q 40/03; G06F 16/288; G06N 20/00

(57) ABSTRACT

Aspects include a system and method of automatic data segmentation to optimize a client's collection efforts against individuals serviced by the client. At least accounts receivables data, historical payment data, and credit related data associated with an individual may be provided to a model as input data to predict a recovery value for the individual. The recovery value may be a weighted average of a unit yield and recovery rate. Based on the predicted recovery value and client-provided segmentation boundaries that define segments as a range of recovery values, the individual may be assigned to a segment. The segment may inform the client of a particular collection strategy for the individual to optimize collection efforts. Additionally, recovery values for the individuals serviced by the client may be provided to a comparison system and utilized to directly compare collection efforts across a plurality of clients nationally and/or demographically.

### CROSS REFERENCE TO RELATED APPLICATIONS

This application claims the benefit of U.S. patent application Ser. No. 16/521,267, filed Jul. 24, 2019, titled “AUTOMATIC DATA SEGMENTATION SYSTEM,” and U.S. Provisional Application No. 62/702,646, filed Jul. 24, 2018, titled “Auto-Segmenter for Collections Optimization,” which are incorporated herein by reference in their entirety.

### BACKGROUND

Service-related expenses for providers, particularly in the healthcare industry, are rising every year. To provide these services to individuals at a competitive rate and avoid passing along the rising costs (e.g., in a form of higher insurance deductibles), service providers often strive to increase collection efforts. For example, the service providers may work to develop strategies for collecting balances owed by individuals in view of the limited resources of the service providers to ultimately maximize returns.

However, predicting whether or not an individual is going to pay and how much they will pay is dependent on a large number of variables, particularly in the healthcare context where insurance is also involved. Due to complexity created by the large number of variables, accurate and timely predictions may be difficult to obtain using conventional techniques. Moreover, due to the highly specific nature of collections strategies from service provider to service provider, collection efforts cannot be directly compared across service providers.

### BRIEF SUMMARY

A system, method and computer readable storage device for automatic data segmentation are described herein. An example automatic data segmentation system may provide a service provider, hereinafter referred to as a client, an easily consumable segment assignment for an individual owing a balance, where the segment assignment informs the collection strategy to be used for the individual to optimize collections efforts. The segment assignment may be based on a predicted recovery value for the individual and client-provided segmentation boundaries defining a range of recovery values for each segment. The recovery value may be predicted by processing at least accounts receivable data, payment history data, and credit related data of the individual using a client-specific, hyper-dimensional model trained with historical data of individuals serviced by the client.

Additionally, by utilizing recovery values for individuals, direct comparisons of collection efforts may be made across clients nationally and/or demographically, among other examples. Clients may use these comparisons to determine adjustments or improvements that can be made to their collection strategies for particular segments, for example, which may further aid in optimizing collections efforts.

In one example aspect, automatic data segmentation may be provided as a

service to health care clients, where the data segmentation system may be communicatively coupled to various systems of the healthcare clients, such as health information systems, to facilitate communication of information between the systems. In another example aspect, automatic data segmentation may be provided as a service to other service providers that are required to collect payments from individuals after rendering services to the individuals, among other examples.

This summary is provided to introduce a selection of concepts; it is not intended to identify all features or limit the scope of the claimed subject matter.

### BRIEF DESCRIPTION OF THE DRAWINGS

The accompanying drawings, which are incorporated in and constitute a part of this disclosure, illustrate various aspects and examples of the present invention:

FIG. 1 is a block diagram of an example environment in which systems of the present disclosure can be implemented;

FIG. 2 is a block diagram illustrating an example data segmentation system in accordance with some embodiments;

FIG. 3A is a diagram illustrating an example model of the data segmentation system in accordance with some embodiments;

FIG. 3B is a diagram illustrating the example model of the data segmentation system following spline interpolation in accordance with some embodiments;

FIG. 4 is a block diagram illustrating an example comparison system in accordance with some embodiments;

FIG. 5 is an example user interface (UI) displaying comparison results in accordance with some embodiments;

FIG. 6 is a process flow diagram illustrating an example method for training a model for automatic data segmentation;

FIG. 7 is a process flow diagram illustrating an example method for automatic data segmentation in accordance with some embodiments;

FIG. 8 is a process flow diagram illustrating an example method for comparing segmentation data across a plurality of clients in accordance with some embodiments;

FIG. 9 is a block diagram illustrating physical components of an example computing device with which the data segmentation system may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications can be made to the elements illustrated in the drawings, and the methods described herein can be modified by substituting, reordering, subtracting, and/or adding operations to the disclosed methods. Accordingly, the following detailed description does not limit the present disclosure, but instead, the proper scope of the present disclosure is defined by the appended claims. The following detailed description is, therefore, not to be taken in a limiting sense.

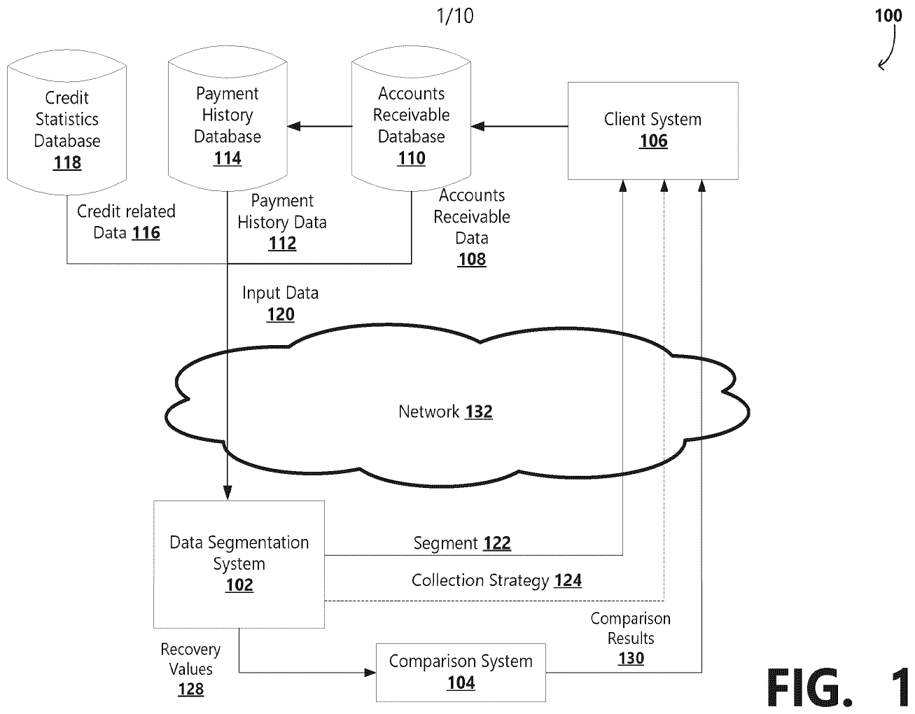

FIG. 1 is a block diagram of an example environment 100 in which systems of the present disclosure can be implemented. Example systems may include one or more of a data segmentation system 102 and a comparison system 104. In some examples, the data segmentation system 102 and the comparison system 104 may be sub-systems integrated in a single system. In other embodiments, the data segmentation system 102 and the comparison system 104 may be separate systems communicatively coupled to one another over a network 132. Additionally, the data segmentation system 102 and the comparison system 104 may be communicatively coupled with a system associated with a client, hereinafter referred to as client system 106, over the network 132. In example aspects, the client may be a healthcare service provider, such as a hospital, a diagnostic center, or a doctor's office, among other similar providers, and the client system 106 may be a health information system (HIS) or other similar system of the healthcare service provider.

The client system 106 may be a data source comprising information about individuals serviced by the client, including accounts receivable data 108, among other information. For example, when an individual receives services from the client, the client system 106 may create profiles for the clients and add invoices for the services to the client profiles, where the generated invoices may comprise accounts receivable data 108.

The accounts receivable data 108 for each individual may include a total cost for the service(s) rendered, a cost responsibility of a guarantor if any (e.g., cost to be paid by insurance), a cost responsibility of the individual, an amount currently owed by the individual (e.g., a balance), an amount of payments made toward the cost, and other similar information. In example aspects, the client system 106 periodically provides the accounts receivable data 108 to the data segmentation system 102. For example, the client system 106 may provide accounts receivable data 108 every quarter of a year. The time period for providing the accounts receivable data 108 may be dynamically configurable by the data segmentation system 102 or the client.

The accounts receivable data 108 may be stored in an accounts receivable database 110. In some aspects, before being stored in the accounts receivable database 110, the accounts receivable data 108 may be processed to comply with a format of the accounts receivable database 110. The accounts receivable data 108 for an individual may be one type of data received as input data 120 for processing at the data segmentation system 102.

Payment history data 112 for the individual may be another type of data received as input data 120 for processing at the data segmentation system 102. In example aspects, payment history data 112 may be created from the accounts receivable data 108 for the respective individual and stored in the payment history database 114. In some examples, the payment history data 112 may be created by the data segmentation system 102. In other examples, the payment history data 112 may be created by the client system 106. The payment history data 112 may include invoices created for the individual over a predetermined time period, payments received from the individual for the created invoices, a time gap between the creation of the invoices and receipt of the payments, unpaid invoices, and delays associated with the unpaid invoices, among other similar information. The payment history data 112 may reveal whether the individual has ever paid the client, if there are patterns of the individual being in debt, etc.

In addition to the accounts receivable data 108 and the payment history data 112, credit related data 116 of the individual may be a further type of data received as input data 120 for processing at the data segmentation system 102. The credit related data 116 may be received from a credit statistics database 118, and include credit scores or credit report data. The credit data may obtained from a third party data source such as a credit rating entity or a credit bureau and stored in the credit statistics database 118. In some aspects, the credit score may be a healthcare-specific credit score. Additionally, other attributes including a service type (e.g., an emergency visit, an inpatient visit, or an outpatient visit) may be received as input data 120 for processing at the data segmentation system 102.

In some aspects, one or more of the accounts receivable database 110, the payment history database 114, and the credit statistics database 118 may be databases associated with the client system 106. In other aspects, one or more of the accounts receivable database 110, the payment history database 114, and the credit statistics database 118 may be databases associated with the data segmentation system 102. In further aspects, one or more of the accounts receivable database 110, the payment history database 114, and the credit statistics database 118 may be databases associated with a third party service, such as an online storage service, communicatively coupled to the data segmentation system 102 and the client system 106 over the network 132.

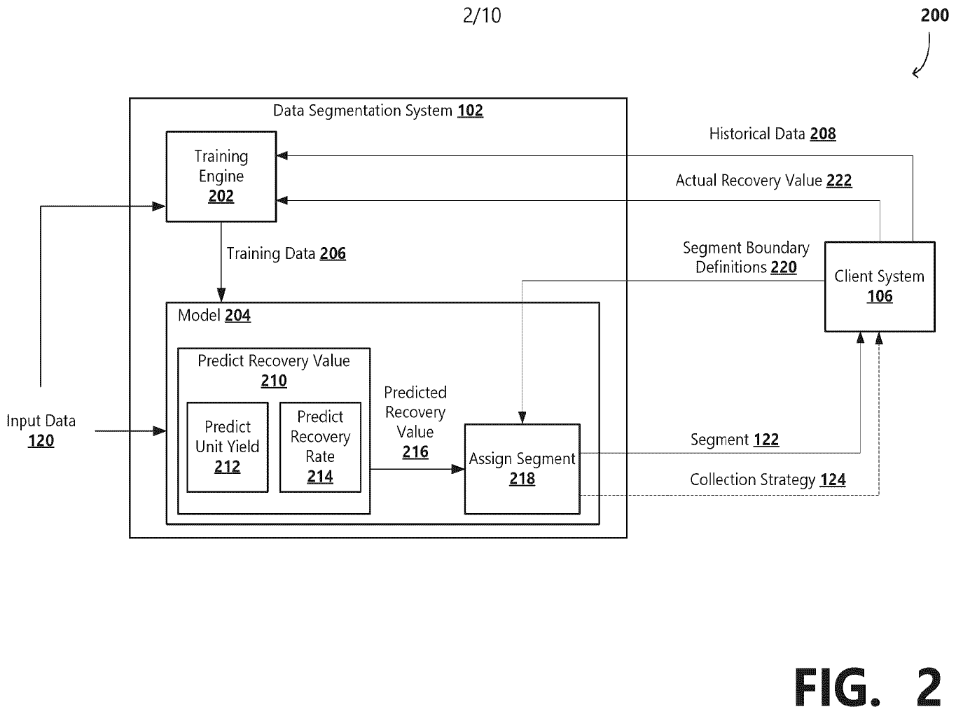

Once the input data 120 for the individual is received at the data segmentation system 102, the input data 120 may be processed using a model, and a segment 122 for the individual may be provided as output. For example, as described in detail in FIG. 2, a recovery value may be predicted for the individual based on the input data 120 using the model. The predicted recovery value may be a weighted average of a predicted unit yield and a predicted recovery rate determined from the modeling of the input data 120. The predicted unit yield may be a total monetary amount predicted to be received from the individual and the predicted recovery rate may be the percentage of the total amount that the individual is predicted to pay (e.g., a ratio of the monetary amount expected to be received to a total cost responsibility of the individual).

The segment 122 provided as output may be an easily consumable value (e.g., segment 1, 2, 3, 4, 5 or segment A, B, C, D, E) that informs a collection strategy for individuals falling within the segment in order to optimize collection efforts. The segment 122 may be determined based on the predicted recovery value and segment boundary definitions provided by the client system 106. For example, the boundary definitions define a range of recovery values for each segment. Therefore, the segment 122 determined may be the segment 122 comprising the range of recovery values in which the predicted recovery value falls. In some aspects, the client system 106 may determine the segment boundary definitions to provide based on resources of the client (e.g., a number of staff, hours, and other resources that may be dedicated to collection efforts). For example, if the client has adequate staff to work 10% of all the clients, the segmentation may be allocated accordingly.

The segment 122 for the individual may be provided to the client system 106. In some examples, the segment 122 may be provided along with the amount owed by the individual in a flat file. The client system 106 may determine a corresponding collection strategy 124 based on the segment 122 assigned to the individual. The collection strategies may vary in timing (e.g., a day/time of day or a frequency at which to contact the client) and a level of interaction (e.g., phone, email, letter, no communication).

To provide an example, one segment may be defined by a range of recovery values indicating individuals falling within the segment are not likely to pay at all, or if so only a minimal amount. Therefore, to avoid wasting any time or resources on sending letters to and/or calling that individual, the collection strategy for the individual may be to write off the unpaid costs and/or get a charitable organization involved to help with the payment. To provide another example, another segment may be defined by a range of recovery values indicating individuals falling within the other segment are likely to pay but have a low balance (e.g., because they are insured and the insurance provider is paying for a large portion of the total cost). Accordingly, the collection strategy for the individual may be to write to the individual or call the individual at least once to prompt payment because the individual is likely to pay, but not to waste too many resources by repetitively contacting the individual as the amount that will be collected is low.

Optionally, in some aspects, the data segmentation system 102 may automatically determine the collection strategy 124 based on the segment 122 and provide both the segment 122 and the collection strategy 124 to the client system 106. In one example, the data segmentation system 102 may receive data from the client system 106 associated with each strategy and the one or more segments the strategy is applicable to. In another example, the data segmentation system 102 may independently suggest the collection strategy 124, where the collection strategy can be suggested based on various factors, such as certain business rules (that is, charity rules, write-off rules), staff size, and whether the client has an auto dialer system versus manual dialing, among other similar factors.

To provide an example scenario, a woman may have an emergency delivery of her baby performed at a local hospital. The total cost of the emergency procedure may be $30,000. However, the woman may have insurance, and only be responsible for $2,000 of that total cost. Therefore, the $2,000 (e.g., one variable of the accounts receivable data 108) may be input to the model along with other data associated with the woman, such as her credit score of 750 (e.g., one variable of the credit related data 116) and no outstanding balances revealed by her past payment history (e.g., one variable of the payment history data 112). Based on this input, the model may yield a predicted unit yield of $1,800 and a predicted recovery rate of 80%, where the predicted recovery value may be a weighted average of the unit yield and recovery rate. The predicted recovery value may fall within the range of recovery values corresponding to segment two based on the segment boundaries provided by the local hospital. Therefore, the data segmentation system 102 may provide the segment two to the local hospital along with the $2000 amount owed as output. The local hospital may then utilize the segment two assignment to determine a collections strategy for collecting the $2,000 from the woman. For example, in this example, segment two may indicate a good likelihood that the client will pay a majority of the remaining costs due. Therefore, the local hospital may devote resources to having staff follow up with phone calls or letters to the woman.

As another example, if the payment history data 112 of the woman in the previous example revealed three previous accounts totaling to $1,500.00 and two of them are in bad debt, the woman may be instead assigned to a segment four. For example, based on this input, the model may yield a predicted unit yield of $800 and a predicted recovery rate of 33%, where the predicted recovery value may be a weighted average of the unit yield and recovery rate. The predicted recovery value may fall within the range of recovery values corresponding to segment four based on the segment boundaries. Adjustment of the classification to segment four may indicate that even though the woman has a good credit score and insurance, etc., the woman is less likely to make payments to the hospital than if the woman had no previous outstanding balances. Hence, as illustrated by these examples, the input data 120 for the individual includes a plurality of variables influencing the recovery value, and a change in one or more of the variables may drastically shift the segment assigned for the individual.

In further example aspects, recovery values 128 for individuals serviced by the client (as well as a plurality of other clients) may be provided from the data segmentation system 102 to the comparison system 104. The recovery values 128 may serve as a standard metric for comparison across the plurality of clients to reveal how collection efforts of one client are comparing to other clients as a whole. For example, the recovery values 128 for each of the plurality of clients may be aggregated and averaged for comparison to the average recovery values for the client to produce comparison results 130.

Additionally, to make the comparison results 130 more meaningful to the client, the comparison results 130 may be returned according to the client's segments. For example, the client's segmentation boundaries may be provided to the comparison system 104 and applied to the aggregated recovery values from the plurality of clients to determine the average recovery value for each of the client's segments across the plurality of clients. This enables direct comparison to the average recovery values of the client for each segment. Therefore, the client is enabled to see in which particular segments the client is over performing or underperforming compared to other clients and may adjust resources accordingly. In some examples, the comparison may be across an entirety of clients, where in some aspects, the entirety of clients may be located within a defined geographical area (e.g., nation, state, city, county, etc.). In other examples, the comparison may be across a subset of clients having similar demographics to provide an “apples to apples” comparison.

FIG. 2 is a block diagram 200 depicting further aspects of a data segmentation system 102. An example data segmentation system 102 may include at least a training engine 202 and a model 204.

The training engine 202 may use historical data 208 received from the client system 106 to produce training data 206. In example aspects, the historical data 208 may correspond to a predetermined time period. For example, the historical data 208 may include data for individuals who received services from the client in the previous six months. The historical data 208 may include input data and an actual recovery value for each of those individuals. Accordingly, the modeling of the training data 206 may reveal relationships between the input data and the actual recovery value.

The input data provided as part of the historical data 208 may be similar to the input data 120, including accounts receivable data 108, payment history data 112, and credit related data 116 for each of the individuals serviced by the client in the past. The actual recovery value provided as part of the historical data 208 may include an actual unit yield and an actual recovery rate based on the amount the individual actually paid toward the cost of the service. For example, the actual unit yield may be the actual monetary amount received from the individual. The actual recovery rate may be the ratio of the monetary amount received from the individual to a total monetary amount due for the service. For example, if a client was responsible for $10,000 worth of service, and paid $8,000 of the total, the actual unit yield may be $8,000 and the actual recovery rate may be 80% or 0.8.

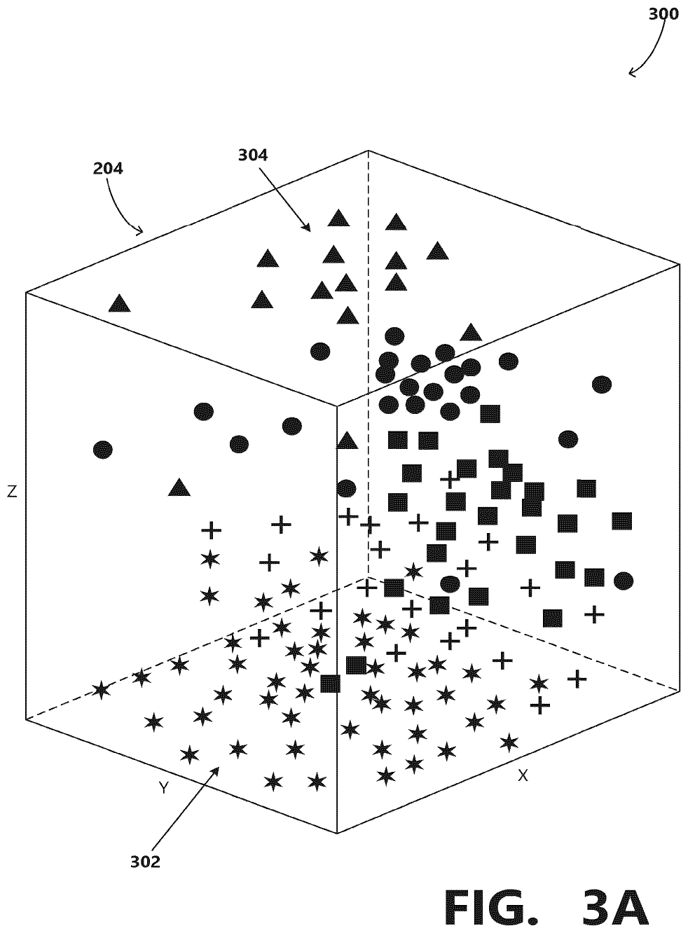

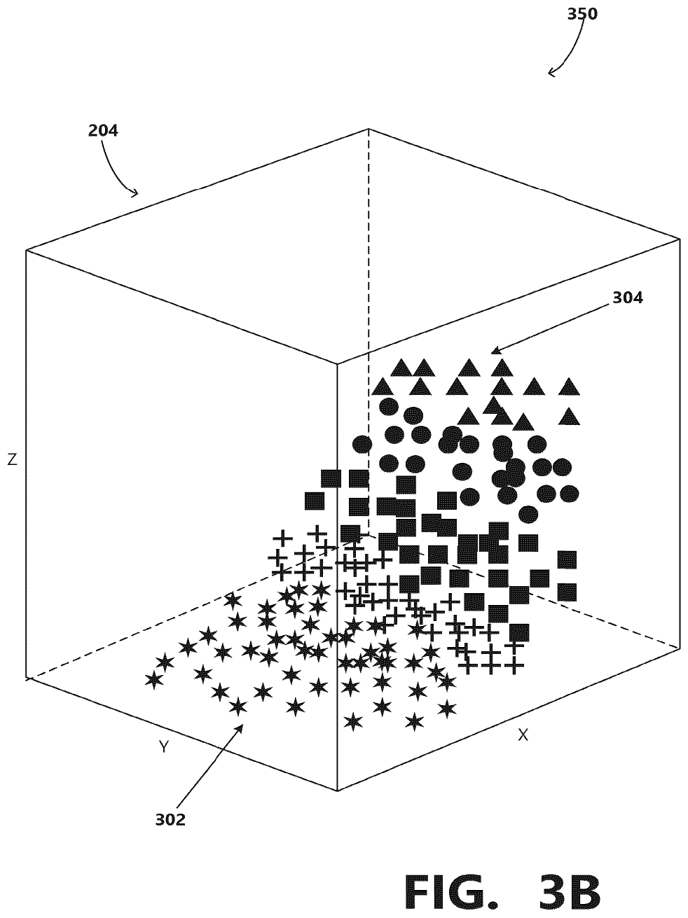

The model 204 may be built based on the training data 206. An example of the model is illustrated in FIGS. 3A and 3B, described in further detail below. The model 204 may be hyper-dimensional, having a dimension for each variable within the training data 206 (e.g., each of the various input data and the unit yield and the recovery rate comprising the actual recovery value). For example, each individual may be represented by a single data point in the model 204, where a unit yield may be represented on an x-axis, a recovery rate may be represented on a y-axis, a credit score may be represented on a z-axis, a cost responsibility may be represented on an n-axis, etc. In some aspects, spline interpolation may be performed in each dimension to smooth the data in the model 204.

Regression analysis may be performed on the data within the model 204 to estimate relationships among the variables, such as the various types of input data and the actual recovery value. For example, the actual recovery value may be a dependent variable of interest, where the various types of input data may be independent variables influencing the actual recovery value. As a result of the regression analysis, a formula may be generated that represents the estimated relationship between the various types of input data and the actual recovery value. For example, if a value for each of the various types of input data are plugged into the formula, the recovery value (e.g., the weighted average of the unit yield and the recovery rate) may be computed as output.

Once the model 204 has been trained, the model 204 may then be implemented at operation 210 to determine a predicted recovery value 216 for a new individual (e.g., an individual who recently received a service) by leveraging the estimated relationship determined by the regression analysis. For example, the input data 120 for the new individual may be fed into the model 204 (e.g., the generated formula) to predict a unit yield at operation 212 and predict a recovery rate at operation 214. The predicted unit yield may be the total monetary amount predicted to be received from the individual and the predicted recovery rate may be the predicted percentage of the total amount that the individual will pay. A weighted average of the predicted unit yield and the predicted recovery rate may then yield the predicted recovery value 216 for the individual.

The individual may then be assigned a segment 122 at operation 218. For example, the segment 122 for the individual may be assigned based on the predicted recovery value 216 determined at operation 210 and segment boundary definitions 220 received from the client system 106. The segment boundary definitions 220 may include boundaries for a plurality of segments. For example, each segment may comprise a range of recovery values. Therefore, the segment 122 assigned may be the segment 122 having a range of recovery values within which the predicted recovery value 216 falls.

In some aspects, the segment 122 may then be provided to the client system 106 for use in determining a collection strategy. Optionally, in some aspects, the data segmentation system 102 may automatically determine the collection strategy 124 based on the segment 122 and provide both the segment 122 and the collection strategy 124 to the client system 106. As one example, the data segmentation system 102 may receive data from the client system 106 associated with each strategy and the one or more segments the strategy is applicable to. As another example, the data segmentation system 102 may independently suggest the collection strategy 124, where the collection strategy can be suggested based on various factors, such as certain business rules (that is, charity rules, write-off rules), staff size, and whether the client has an auto dialer system versus manual dialing, among other similar factors.

The model 204 may be continuously updated over time. For example, once an actual recovery value 222 is determined for the new individual, the actual recovery value 222 may be provided along with the input data 120 of the new individual to the training engine 202 to update the training data 206 and subsequently the model 204. The model 204 may be updated by using the actual recovery value 222 as either learning data or as validation data. For example, the model 204 may be patched based on the actual recovery value 222. Patching of the model 204 may include updating weights assigned to one or more variables or adding or removing one or more variables from the model 204. In some aspects, the model 204 is updated multiple times until an acceptable error rate for the model 204 is achieved.

In addition to updating the model 204, the segment boundary definitions 220 of the client may be updated as well. For example, one or more boundaries associated with one or more segments of the model 204 may be adjusted based on the actual recovery value 222.

FIG. 3A is a diagram 300 illustrating an example model 204 of the data segmentation system 102 in accordance with some embodiments. As previously discussed in conjunction with FIG. 2, the model 204 may be hyper-dimensional, having a dimension for each data variable used to train the model 204. For example, the training data 206 may be produced from historical data 208 comprised of various types of input data (e.g., accounts receivable data 108, payment history data 112, and credit related data 116) and an actual recovery value including an actual unit yield and an actual recovery rate for each of a plurality of individuals that have historically received services from the client. Therefore, the model 204 may include a dimension for each of the various types of input data, the actual unit yield, and the actual recovery rate. Each individual from the plurality of individuals that have historically received services from the client may be represented by a corresponding data point in the hyper-dimensional space.

Additionally, segment boundary definitions 220 may be received from the client and applied to the data within the model 204. The segment boundary definitions 220 may define a plurality of segments based on recovery values. For example, each segment may correspond to a range of recovery values. Accordingly, each data point may be illustrated by a different symbol type based on the segment into which a corresponding individual is classified or assigned. The segment may inform one or more collections strategies applied to the individuals assigned to the segment.

To provide an example, a first set of data points 302, illustrated as stars in FIGS. 3A and 3B, may represent individuals assigned to a first segment. In example aspects, the first segment includes non-paying individuals. That is, the first segment includes individuals who made no payment within a predetermined time period after the service was rendered (e.g., actual unit yields and actual recovery rates of 0). For first segment individuals, the collection strategy may be to send invoices of the individuals to a debt collection agency or to write off the invoices under charitable deductions. Thus, the client optimizes their collections effort by circumventing certain collections activities, such as sending letters or calling the individuals that are wasting limited resources and are unlikely to be successful in persuading these non-paying individuals to pay.

As another example, a second set of data points 304, illustrated as triangles in FIGS. 3A and 3B, may represent individuals assigned to a second segment. In example aspects, clients in the second segment have low balances and may be able and likely to pay those amounts. However, because these balances are low, actions for collection on these client accounts may not be prioritized.

The various other sets of data points illustrated as circles, squares, and crosses that fall in between the first set of data points 302 and the second set of data points 304 in FIGS. 3A and 3B may represent other segments. In example aspects, these other segments include individuals who have higher balances and may have paid some towards their owed amounts. Therefore, it may be worthwhile for the client to contact individuals in these segments to obtain payments from or to enroll in payment plans, for example. That is, these segments may be prioritized, and more collection strategy resources dedicated to these clients.

As illustrated in FIG. 3A, the boundaries of the segments of the model 204 are not well defined. Outlier data points may also make it difficult to define. To provide better definition, the boundaries of the segments may be smoothened using a polynomial interpolation method, such as spline interpolation. During the interpolative smoothening, equidistant points in a dimension of the model 204 may be picked by density of the data, and a curved line set for those equidistant points. The process may be repeated in each dimension of the model 204. The combination of the curved lines may then become a smooth surface. The result of spline interpolation on the model 204 is illustrated in FIG. 3B.

FIG. 3B is a diagram 350 illustrating an example model 204 of the data segmentation system 102 following spline interpolation in accordance with some embodiments. Interpolative smoothening may lower a variability in the modeled data in order to ascertain a more accurate expected value of the reward of the collection effort (e.g., a more accurate recovery value) and thus enable more accurate segment assignment. For example, the z axis may represent a recovery rate, and following spline interpolation, the second set of data points 304 in the model 204 of FIG. 3B reveal a lower recovery rate than the second set of data points 304 in the model 204 of FIG. 3A. This results from a subset of the first set of data points 302 being underneath the second set of data points 304 in FIG. 3A that, when identified, dilutes the recovery rate of the second set of data points 304 to the level illustrated in FIG. 3B. For example, the recovery rate may be diluted from a rate of about 90% to a rate of about 60%.

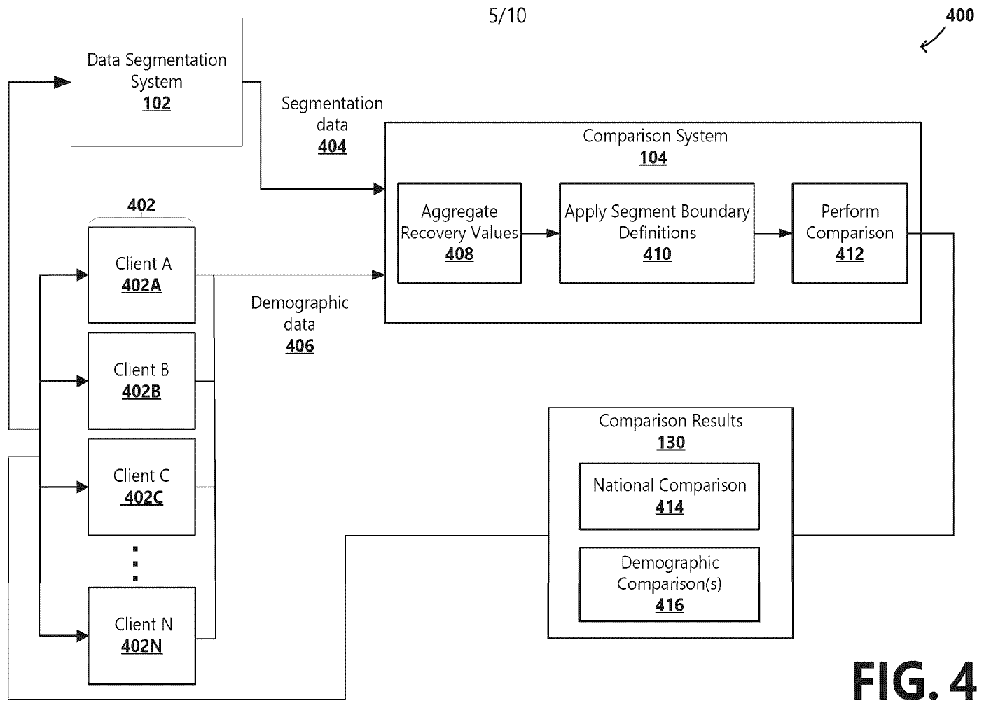

FIG. 4 is a block diagram 400 illustrating an example comparison system 104 in accordance with some embodiments. In some examples, the comparison system 104 may be integrated with a data segmentation system 102 in a single system. In other embodiments, the comparison system 104 may be a separate system communicatively coupled to the data segmentation system 102.

The data segmentation system 102 may build a plurality of models similar to model 204, where each of the plurality of models is specific to a particular client. For example, the data segmentation system 102 may build models specific to each of a plurality of clients 402A, 402B, 402C, and 402N, collectively clients 402, as described in detail in conjunction with FIG. 2. Recovery values for each individual serviced by the clients 402 (e.g., actual recovery values used to train/update the respective models) may serve as a consistent performance metric across the clients 402, and may be provided from the data segmentation system 102 to the comparison system 104. Additionally, the data segmentation system 102 (or alternatively the clients 402) may provide the segment boundary definitions for each client to the comparison system 104 to allow for a more meaningful comparison to a requesting client, as described in detail below. The recovery values and segmentation boundary definitions received at the comparison system 104 may be collectively referred to as segmentation data 404. In some aspects, permission to receive and store the segmentation data 404 may be provided by the clients 402 via contractual obligations with the provider of the data segmentation system 102 and/or the comparison system 104, or via a UI functionality user agreement wherein upon utilizing the comparison system 104 to receive comparison results 130 the client agrees to share its data.

Demographic data 406 for each of the clients 402 may be provided by the respective clients 402 to the comparison system 104. Examples of the demographic data 406 provided may include a type of the client (e.g., a hospital, a health clinic, a diagnostic center, a doctor's office, etc.), a location of the client (e.g., inner city, suburban, rural), and an average level of income of individuals receiving service from the client (e.g., upper class, middle class, lower class), among other demographic data. For example, Client A 402A may a hospital located in a rural area servicing individuals with a low to middle median income, Client B 402B may be a small health clinic located in the inner city that works largely off of charity, and Client C 402C may be a hospital located in a suburb servicing individuals with a high median income.

Upon receipt of a request for a comparison from a given client (e.g., a requesting client), the comparison system 104 may aggregate recovery values for one or more of the clients 402 at operation 408. The recovery values may be aggregated based on a type of comparison requested. As one example, the request may be for a comparison across an entirety of the clients 402. Therefore, recovery values for the entirety of the clients may be aggregated. In some aspects, the entirety of the clients 402 may be spread over a particular geographical area, such as a nation, and thus the comparison yielded may be a national comparison (e.g., national comparison 414). As another example, the request may be for a comparison across a subset of the clients 402 that are demographically similar to the requesting client (e.g., demographic comparisons 416). For example, if the requesting client is Client A 402A, the hospital located in the rural area servicing individuals with a low to middle median income, it may be more insightful for Client A 204A to compare its collections efforts to those of other similar rural hospitals, rather than inner city or suburban hospitals servicing different types of individuals. The demographic data 406 may be used to aid in determinations of demographically similar clients. In further examples, the request may be for more than one comparison, where the comparisons are a mix of national and demographic related comparisons.

To make the comparison results more meaningful to the requesting client, at operation 410, segment boundary definitions for the requesting client may be applied to the aggregated recovery values so that the comparison may be performed on a per segment basis corresponding directly to the segments of the requesting client. For example, if the requesting client has five segments defined. The aggregate recovery values may be divided within those five segments as defined by the requesting client.

Then, at operation 412 the comparison may be performed. For example, for each segment, aggregated recovery values falling within the segment may be averaged to produce an average aggregated recovery value across the clients for each segment. Similarly, for each segment, the requesting client's recovery values falling within the segment may be averaged. The average aggregated recovery value across the clients may then be directly compared to the average recovery value of the requesting client on a per segment basis. In some examples, the comparison may further be broken down to a comparison of the average unit yield and the average recovery rate across the clients to the average unit yield and the average recovery rate of the requesting client.

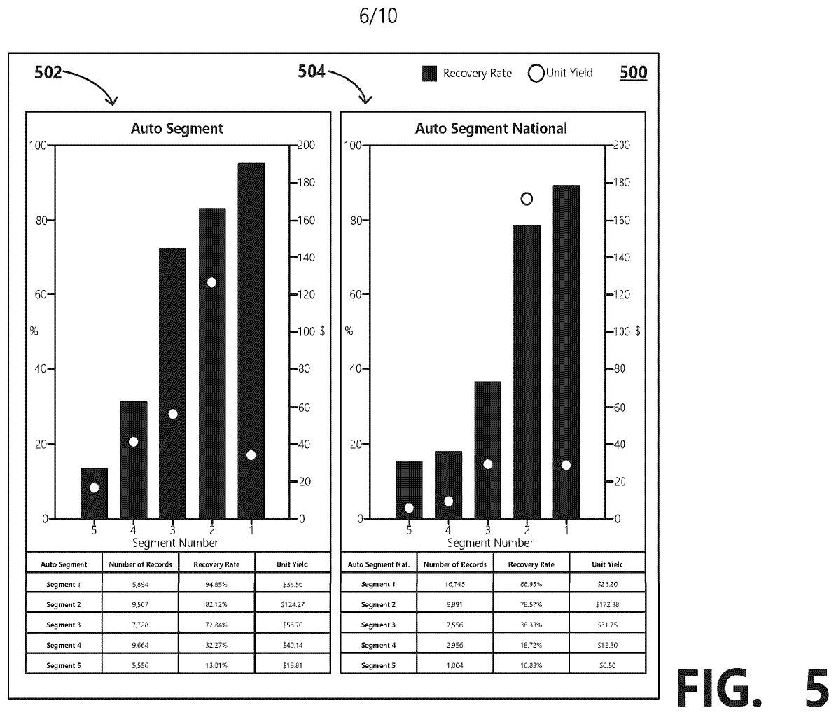

The comparison results 130 may then be provided to the requesting client for use in collections strategies optimization. The comparison results may include one or more of a national comparison 414 (or other similar geographic based comparison, such as state-wide, city-wide, etc.) and demographic comparisons 416 based on a type of comparison requested. The comparison results 130 may be provided in a graphical and/or tabular form as illustrated in FIG. 5.

The comparison results 130 may allow the requesting client to directly compare its recovery values in each segment to those same metrics averaged nationally and/or demographically to determine whether they are comparatively collecting successfully, average, or poorly in one or more of the segments. The requesting client may then adjust their collection strategies for each segment accordingly. For example, if the requesting client is Client A 402A, and the comparison results 130 indicate that nationally they are not collecting as successfully from clients falling within segment two, Client A 402A may dedicate more resources to those individual assigned to segment two (e.g., use more aggressive collection strategies such as phone calls and letters) to try to increase amounts collected from individuals within segment two.

FIG. 5 is an example user interface (UI) 500 displaying comparison results 130 in accordance with some embodiments. As illustrated, the comparison results 130 may include a national comparison 414. In other aspects, the comparison results 130 may additionally or alternatively include one or more demographic comparisons 416.

For example, a client may request to receive a national comparison. As described in greater detail in FIG. 4, the comparison system 104 may aggregate recovery values of individuals serviced by all clients nationwide, apply segmentation boundary definitions of the requesting client to the aggregated recovery values, and perform the comparison on a per segment basis by determining and comparing an average aggregated recovery value nationally to an average recovery value of the requesting client. The comparison system 104 may return within the comparison results 130 a first data set 502 and a second data set 504 for display in the UI 500. The first data set 502 displayed may provide the average recovery value of the requesting client for each segment of the requesting client. The second data set 504 displayed may provide an average aggregated recovery value for each segment across an entirety of clients nationally.

As illustrated, each of the first data set 502 and the second data set 504 may include one or more of a graph and a table to display the respective average recovery values. For example, the graph may have an x-axis representing the segments defined by the requesting client and a y-axis simultaneously representing an average recovery rate and an average unit yield (e.g., the recovery value). Specifically, the graph may include a bar for each segment depicting the average recovery rate for the respective segment, and a marker for each segment depicting the average unit yield for the respective segment, where the marker may be overlaid on the bar. The right hand side of the graph may be labeled along the y-axis according to the dollar amount for the average unit yield, whereas the left hand side of the graph may be labeled along the y-axis according to percentage for average recovery rate.

The table may include rows for each segment of the requesting client and columns indicating a number of records (e.g., a number of individuals within each segment), an average recovery rate, and an average unit yield for each segment. In some examples, the comparison requested may be a benchmark comparison. In such examples, the table may further include columns indicating an average national benchmark score, a median national benchmark score, and a standard deviation for the national benchmark score to allow for additional insight. As can be appreciated, other graphical and textual representations may be utilized to visualize the average recovery value on a per segment basis.

The first data set 502 may be directly compared to the second data set 504 to enable the requesting client to determine how their collection efforts compare on a per segment basis to other clients nationally and within which segments, if any, adjustments to collection strategies need to be made to optimize efforts. As one example, for individuals falling within segment five, the requesting client may have a recovery rate of about 13% and a unit yield of almost $19, whereas nationally clients may have a national recovery rate of almost 17% and the national unit yield of almost $6.50. Based on this comparison, the requesting client may determine that the national recovery rate is higher and thus the requesting client may consider devoting more resources into collecting from individuals assigned to segment five. However, because the national unit yield is lower, even if the requesting client put more resources into collecting from individuals assigned to segment five, the extra resources devoted may not be worth the low monetary reward gained from those individuals. Thus, depending on the comparisons in other segments, those extra resources may instead be allocated elsewhere to maximize return.

As another example, for individuals falling within segment one, the requesting client may have a recovery rate of almost 95% and a unit yield of about $35, whereas nationally clients may have a national recovery rate of almost 89% and a national unit yield of about $28. Based on this comparison, the requesting client may determine they have a better recovery rate and a unit yield than the national recovery rate and the national unit yield, and therefore no additional resources may need to be devoted to individuals assigned to segment one.

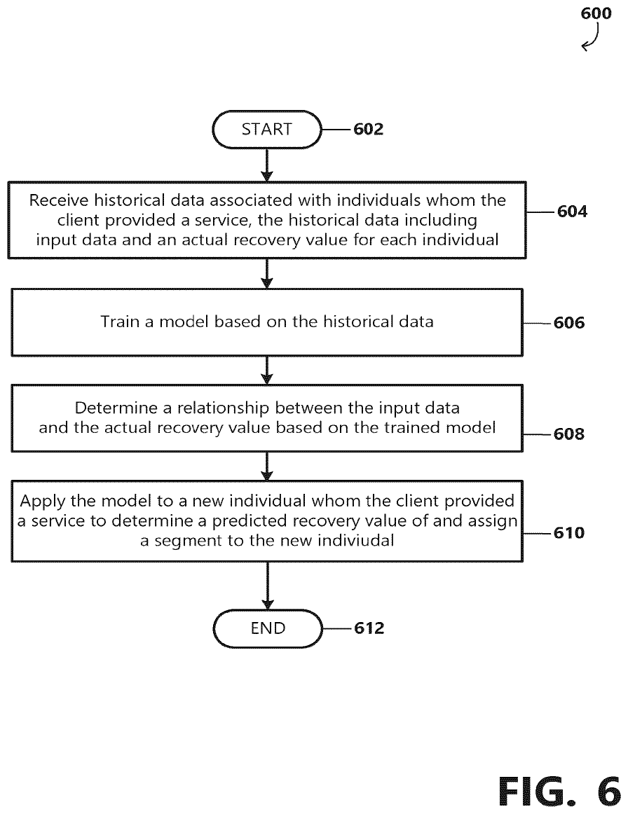

FIG. 6 illustrates a method 600 of training a model for automatic data segmentation. In example aspects, the method 600 may be performed by the data segmentation system 102. The method 600 may start at operation 602 and proceed to operation 604, where historical data 208 associated with individuals whom the client has provided a service may be received. The historical data 208 may include input data and an actual recovery value for each individual serviced within a predetermined time period (e.g., individuals provided a service in the previous year). The input data of the historical data 208 may include accounts receivable data 108, payment history data 112, credit related data 116, and other attributes including a service type (e.g., an emergency visit, an inpatient visit, or an outpatient visit). The actual recovery value of the historical data 208 may be a weighted average of an actual unit yield and an actual recovery rate for an individual. The actual unit yield may be the actual monetary amount received from the individual. The recovery rate may be the ratio of the monetary amount received from the individual to a total monetary amount due for the service. Each type of input data, the actual unit yield, and the actual recovery rate may be considered variables of the historical data 208.

At operation 606, a model 204 may be trained based on the historical data 208 (e.g., the historical data 208 may be training data 206). The model 204 may be a hyper-dimensional model, where each variable of the training data 206 is represented by a unique dimension. Therefore, each data point in the model 204 represents an individual from the training data 206 corresponding to respective values of the variables in the hyper-dimensional space. In some examples, spline interpolation methods may be performed in each dimension to smooth the data.

At operation 608, a relationship between the variables of the historical data 208 (e.g., a relationship between the input data and the actual recovery value) may be determined based on the model by performing regression analysis, for example, on the data within the model 204. In some examples, the actual recovery value may be the dependent variable of interest, where the various types of input data may be the independent variables influencing the actual recovery value. As a result of the regression analysis, a formula may be generated to represent the estimated relationship between the variables. For example, if a value for each of the various types of input data are plugged into the formula, the recovery value (e.g., the weighted average of the unit yield and the recovery rate) may be computed as output.

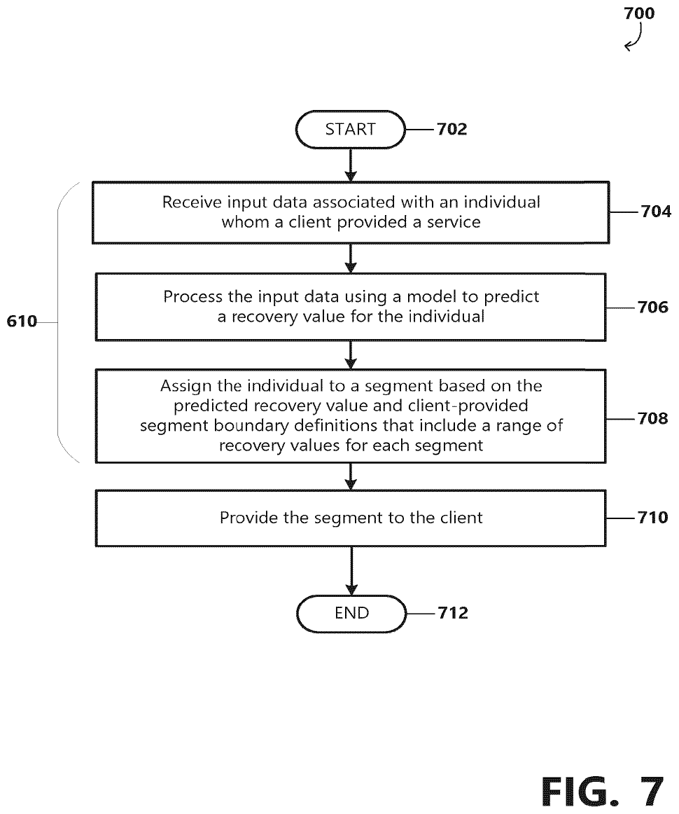

By leveraging the relationships determined by the regression analysis, the model 204 may be applied to predict a recovery value of and assign a segment to a new individual whom the client provided a service at operation 610, as described in greater detail in conjunction with FIG. 7 below. The method may then end at operation 612.

FIG. 7 illustrates a method 700 for automatic data segmentation. In example aspects, the method 700 may be performed by the data segmentation system 102, and operations 704 through 708 can be used to at least partially perform the operation 610.

The method 700 may start at operation 702 and proceed to operation 704, where input data 120 associated with an individual whom a client provided a service may be received. For example, the individual may have recently received a service from a client, and the client may want to determine which collection strategy to apply for the individual to most effectively collect a balance from the individual. In example aspects, the input data 120 includes accounts receivable data 108 (e.g., a total amount owed, a remaining balance owed), payment history data 112 (presence of debts), credit related data 116, and other attributes (e.g., whether the individual has insurance or not, service type (emergency visit, inpatient visit, outpatient visit).

At operation 706, the input data 120 may be processed using a model 204 to predict a recovery value (e.g., predicted recovery value 216) for the individual. The model 204 may be specific to the client. For example, the model 204 may be the model trained at operation 606 and used to determine the relationship between input data and recovery values of historical data 208 of the client at operation 608. In some example aspects, the values of the various types of input data 120 for the individual may be input into the formula generated based on the determined relationship from the model 204, and the predicted recovery value 216 may be provided as output of the formula.

At operation 708, the client may be assigned to a segment 122 based on the predicted recovery value 216 for the client and segment boundary definitions 220 received from the client, where the segment boundary definitions 220 may include a range of recovery values. For example, the segment 122 comprising the range of recovery values into which the predicted recovery value 216 falls may be assigned to the individual.

At operation 710, the segment 122 may be provided to the client. The segment 122 may be utilized by the client to determine a collection strategy for the individual. In some examples, the collection strategy may be determined by the data segmentation system 102 and may be provided, along with the segment 122, to the client. At operation 712 the method 700 ends.

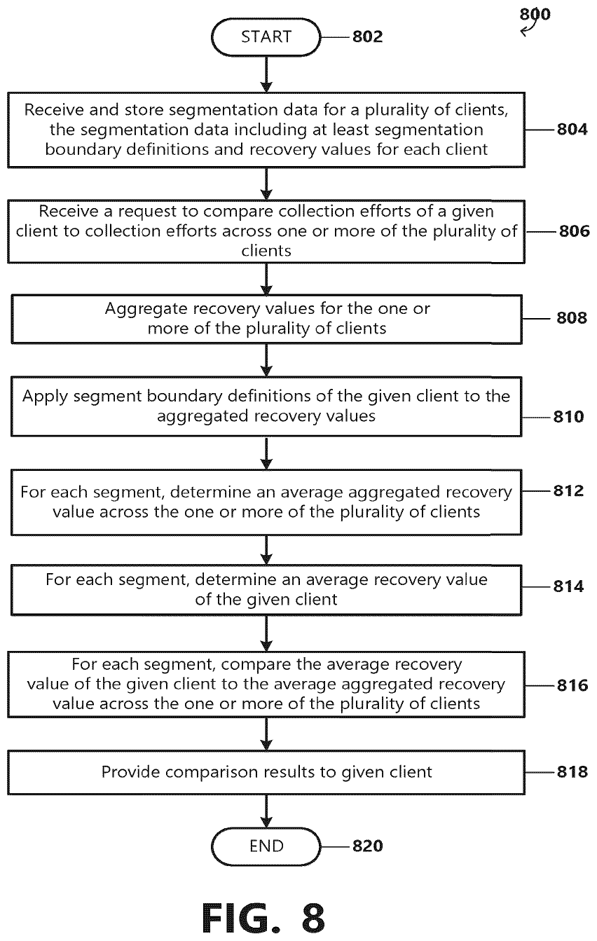

FIG. 8 is a process flow diagram illustrating an example method 800 for

comparing segmentation data across a plurality of clients 402. In example aspects, the method 800 may be performed by comparison system 104, where comparison system 104 may be integrated with the data segmentation system 102 or may be a separate system communicatively coupled to the data segmentation system 102.

The method 800 may start at operation 802 and proceed to operation 804, where the comparison system 104 may receive and store segmentation data 404 for a plurality of clients 402. The segmentation data 404 may include at least recovery values of individuals serviced and segment boundary definitions for each of the plurality of clients 402. Additionally, the comparison system 104 may receive other types of data, such as demographic data 406 associated with each of the plurality of clients 402.

At operation 806, the comparison system 104 may receive a request to compare collection efforts of a given client (e.g., client A 402A) to collection efforts across one or more of the plurality of clients 402. At operation 808, the recovery values for the one or more the plurality of clients 402 may be aggregated. The clients whose recovery values are aggregated may be based on a type of comparison requested. In one example, the requested comparison may be a national comparison. Therefore, recovery values for all of the clients within the nation may be aggregated. In another example, the requested comparison may be a demographic comparison. Therefore, recovery values for only a subset of clients that possess similar demographic characteristics to the given client (e.g., based on the demographic data 406) may be aggregated.

To allow a direct and meaningful comparison, recovery values across the

clients 402 may be normalized based on the segments defined by the given client. For example, at operation 810, segment boundary definitions 220 of the given client may be applied to the aggregated recovery values. For example, the requesting client may have defined five segments, each segment corresponding to a particular range of recovery values. The aggregated recovery values may then be divided into those five segments.

Then, at operation 812, an average aggregated recovery value across the one or more of the plurality of clients 402 may be determined for each segment. For example, all aggregated recovery values falling within a same segment may be averaged together to produce an average aggregated recovery value for the particular segment, which may then be repeated for each segment. At operation 814, an average recovery value of the given client may be determined for each segment. For example, all recovery values for the given client falling within a same segment may be averaged together to produce an average recovery value for the particular segment, which may then be repeated for each segment.

At operation 816, for each segment, the average recovery value for the given client determined at operation 814 may be compared to the average aggregated recovery value across the plurality of clients determined at operation 812. The comparison results 130 may be provided to the given client at operation 818.

The comparison results 130 may be provided in a graphical and/or tabular form as illustrated in FIG. 5 so that they may be easily consumed and understood by the given client. In example aspects, the comparison results 130 may break down the average recovery value for each segment into an average unit yield and an average recovery rate from which the average recovery value is comprised. The given client may use the comparison results 130 to determine in which segment(s) the given client is underperforming or over-performing relative to other clients nationally and/or demographically to help inform future adjustments of collection strategies and/or resource allocations. The method may end at operation 820.

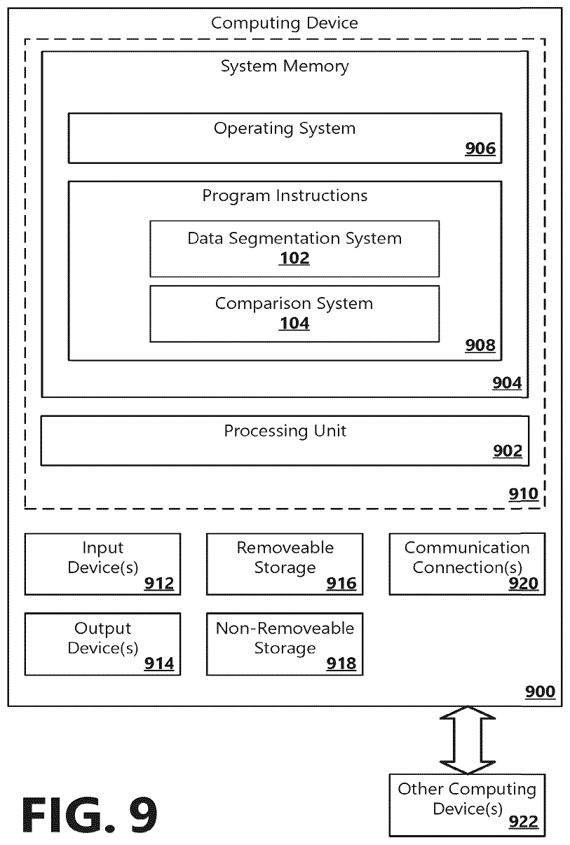

FIG. 9 is a block diagram illustrating physical components of an example computing device 900 with which aspects may be practiced. The computing device 900 can include at least one processing unit or processor 902 and a system memory 904. The system memory 904 may comprise, but is not limited to, volatile (e.g. random access memory (RAM)), non-volatile (e.g. read-only memory (ROM)), flash memory, or any combination thereof. System memory 904 can include operating system 906, one or more program instructions 908 including an automated executable having sufficient computer-executable instructions, which when executed, perform functionalities and features as described herein. For example, the one or more program instructions 908 can include one or more components of the data segmentation system 102 and the comparison system 104.

Operating system 906, for example, can be suitable for controlling the operation of computing device 900 and for instantiating a communication session between one or more local or remote systems/devices. Furthermore, aspects may be practiced in conjunction with a graphics library, other operating systems, or any other application program and is not limited to any particular application or system. This basic configuration is illustrated by those components within a dashed line 910. Computing device 900 can also include one or more input device(s) 912 (keyboard, mouse, pen, touch input device, etc.) and one or more output device(s) 914 (e.g., display, speakers, a printer, etc.).

The computing device 900 can also include additional data or memory storage devices (removable or non-removable) such as, for example, magnetic disks, optical disks, caching data structures, tape, etc. Such additional storage is illustrated by a removable storage 916 and a non-removable storage 918. Computing device 900 can also contain a communication connection 920 that can allow computing device 900 to communicate with other computing devices 922, such as over a network in a distributed computing environment, for example, an intranet or the Internet. Communication connection 920 is one example of a communication medium, via which computer-readable transmission media (i.e., signals) may be propagated.

Programming modules can include routines, programs, components, data structures, and other types of structures that can perform particular tasks or that can implement particular abstract data types. Moreover, aspects can be practiced with other computer system configurations, including hand-held devices, multiprocessor systems, microprocessor-based or programmable client electronics, minicomputers, mainframe computers, and the like. Aspects can also be practiced in distributed computing environments where tasks are performed by remote processing devices that are linked through a communications network. In a distributed computing environment, programming modules can be located in both local and remote memory storage devices.

Furthermore, aspects can be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SoC)). Aspects can also be practiced using other technologies capable of performing logical operations such as, for example, AND, OR, and NOT, including, but not limited to, mechanical, optical, fluidic, and quantum technologies. In addition, aspects can be practiced within a general purpose computer or in other circuits or systems.

Aspects can be implemented as a computer process (method), a computing system, or as an article of manufacture, such as a computer program product or computer-readable storage medium. The computer program product can be a computer storage medium readable by a computer system and encoding a computer program of instructions for executing a computer process. Accordingly, hardware or software (including firmware, resident software, micro-code, etc.) can provide aspects discussed herein. Aspects can take the form of a computer program product on a computer-usable or computer-readable storage medium having computer-usable or computer-readable program code embodied in the medium for use by, or in connection with, an instruction execution system.

Although aspects have been described as being associated with data stored in memory and other storage mediums, data can also be stored on or read from other types of computer-readable media, such as secondary storage devices, like hard disks, floppy disks, or a CD-ROM, or other forms of RAM or ROM. The term computer-readable storage medium refers only to devices and articles of manufacture that store data or computer-executable instructions readable by a computing device. The term computer-readable storage media does not include computer-readable transmission media.

Aspects described herein may be used in various distributed computing environments where tasks are performed by remote processing devices that are linked through a communications network. Aspects described herein can be implemented via local and remote computing and data storage systems. Such memory storage and processing units can be implemented in a computing device. Any suitable combination of hardware, software, or firmware may be used to implement the memory storage and processing unit. For example, the memory storage and processing unit may be implemented with computing device 900 or any other computing devices 922, in combination with computing device 900, wherein functionality can be brought together over a network in a distributed computing environment, for example, an intranet or the Internet, to perform the functions as described herein. The systems, devices, and processors described herein are provided as examples; however, other systems, devices, and processors can comprise the aforementioned memory storage and processing unit, consistent with the described aspects.

According to some aspects, a system for automatic data segmentation is provided. An example system may include a processing unit and a memory coupled to the processing unit. The memory may store instructions that, when executed by the processing unit, may cause the system to receive, from a plurality of data sources, input data associated with an individual whom a client has provided a service, the input data including one or more of accounts receivable data, payment history data, and credit related data associated with the individual, process the input data using a model to predict a recovery value for the individual, assign the individual to a segment based on the predicted recovery value and boundary definitions for a plurality of segments received from the client, the boundary definitions including a range of recovery values for each segment, and provide the segment to the client, wherein the segment informs the client of a collection strategy for the individual.

In other aspects, historical data associated with individuals whom the client provided a service may be received from the client, and the model may be trained with the historical data, where the historical data may include at least input data and a recovery value associated with each individual. The model may be a hyper-dimensional model that includes a dimension for each variable of the historical data. Each individual from the historical data may be represented as a data point corresponding to a value for each variable in the hyper-dimensional model. Spline interpolation may be performed within each dimension of the model.

In further aspects, regression analysis may be performed on the model to determine a relationship between the input data and the recovery value, and generate a formula based on the determined relationship. To process the input data using the model to predict the recovery value for the individual, the input data may be provided as input to the formula to receive the predicted recovery value as output. In response to receiving an actual recovery value for the individual, the model may be updated based on the actual recovery value.

In yet further aspects, segmentation data of the client may be provided to a comparison system communicatively coupled to the system, where the segmentation data may include at least the boundary definitions and recovery values for individuals serviced by the client, and the segmentation data may be used by the comparison system to compare collection efforts of the client to collection efforts across a plurality of clients. The recovery value may be a weighted average of a unit yield and a recovery rate, the unit yield may be a monetary amount received from the individual for the service, and the recovery rate may be a ratio of the monetary amount received from the individual to a total monetary amount due for the service.

In additional aspects, the accounts receivable data may include a total amount owed for the service, an amount owed by a guarantor, an amount owed by the individual, a remaining balance owed by the individual, and/or any payments. The payment history data may include invoices created for the individual over a predetermined time period, payments received from the individual for the invoices, a time gap between creation of the invoices and receipt of the payments, unpaid invoices, and/or time delays associated with the unpaid invoices. The credit related data may include a credit score, credit report data, and/or a healthcare-specific credit score of the individual.

According to some examples, a data segmentation method is provided. An example data segmentation method includes receiving, from a plurality of data sources, input data associated with an individual whom a client has provided a service, the input data including one or more of accounts receivable data, payment history data, and credit related data associated with the individual, and processing the input data using a model to predict a recovery value for the individual. The example data segmentation method may also include assigning the individual to a segment based on the predicted recovery value and boundary definitions for a plurality of segments received from the client, the boundary definitions including a range of recovery values for each segment, and providing the segment to the client, where the segment may inform the client of a collection strategy for the individual.

In other examples, the model may be trained with historical data associated with individuals whom the client provided a service, where the historical data may include at least input data and a recovery value associated with each individual. Regression analysis may be performed on the model to determine a relationship between the input data and the recovery value. A formula may be generated based on the determined relationship, where to process the input data using the model to predict the recovery value for the individual, the input data may be provided as input to the formula and the predicted recovery value may be received as output.

In further examples, the collection strategy may be determined based on the segment, and the collection strategy may be provided to the client along with the segment. Segmentation data of the client may be provided to a comparison system, where the segmentation data may include at least the boundary definitions and recovery values for individuals serviced by the client, and the segmentation data may be used by the comparison system to compare collection efforts of the client to collection efforts across a plurality of clients.

According to some aspects, a comparison system is provided. An example comparison system may include a processing unit, and a memory coupled to the processing unit. The memory may store instructions that, when executed by the processing unit, cause the system to receive and store segmentation data for a plurality of clients, the segmentation data for each client including at least boundary definitions for a plurality of segments and recovery values of individuals serviced, receive a request to compare collection efforts of a given client to collection efforts across one or more of the plurality of clients, aggregate recovery values for the one or more of the plurality of clients; and apply boundary definitions of the given client to the aggregated recovery values. The system may be further caused to, for each segment: determine an average aggregated recovery value across the plurality of clients, determine an average recovery value of the given client, and compare the average recovery value of the given client to the average aggregated recovery value across the plurality of clients and provide comparison results to the given client.

In other aspects, the request to compare collection efforts of the given client to collection efforts across the one or more of the plurality of clients may include a request to compare across an entirety of clients and/or a request to compare across a subset of clients having similar demographic characteristics to the given client. The comparison system may be further caused to receive and store demographic data associated with each of the plurality of clients to enable the comparison across the subset of clients.

The description and illustration of one or more aspects provided in this application are intended to provide a thorough and complete disclosure the full scope of the subject matter to those skilled in the art and are not intended to limit or restrict the scope of the invention as claimed in any way. The aspects, examples, and details provided in this application are considered sufficient to convey possession and enable those skilled in the art to practice the best mode of the claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, aspects, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described can be performed in any order or concurrently. Having been provided with the description and illustration of the present application, one skilled in the art may envision variations, modifications, and alternate embodiments falling within the spirit of the broader aspects of the general inventive concept provided in this application that do not depart from the broader scope of the present disclosure.

1.-20. (canceled)

21. A system for automatic data segmentation, the system comprising:
one or more processors; and
a non-transitory computer readable medium having stored thereon instructions that, when executed by the one or more processors, cause the one or more processors to:
receive, from a client system, input data associated with a first individual of a first plurality of individuals for whom a client system has provided a service;
input, into a hyperdimensional model, the input data, wherein the hyperdimensional model is trained using historical data and a plurality of actual recovery values, wherein the historical data comprises one or more of: historical accounts receivable data, historical payment history data, and historical credit related data, and wherein a first actual recovery value of the plurality of actual recovery values corresponds to a second individual of a second plurality of individuals;
receive, from the hyperdimensional model, output data comprising a predicted recovery value for the first individual, wherein the predicted recovery value is a weighted average of a predicted unit yield and a predicted recovery rate for the first individual,
receive, from the client system, a plurality of segment boundary definitions that define a plurality of segments, where each of the plurality of segments correspond to a range of recovery values;
based on the predicted recovery value, assign the first individual to a first segment of the plurality of segments, wherein the predicted recovery value is within the range of recovery values corresponding to the first segment; and
transmit, to the client system, an electronic message comprising the first segment.

22. The system of claim 21, wherein the predicted unit yield comprises a total monetary amount predicted to be received from the first individual, and wherein the predicted recovery rate comprises a percentage of a total amount owed expected to be received from the first individual.

23. The system of claim 21, wherein the first actual recovery value comprises an actual unit yield and an actual recovery rate, wherein the actual unit yield comprises a total monetary amount received from the second individual, and wherein the actual recovery rate comprises a percentage of a total amount owed that was received from the second individual.

24. The system of claim 21, wherein the input data comprises one or more of: accounts receivable data, payment history data, or payment history data.

25. The system of claim 21, wherein the client system is a first client system of a plurality of client systems, and wherein execution of the instructions further causes the one or more processors to:
aggregate one or more actual recovery values associated with each of the plurality of client systems;
generate a first plurality of partitions by sorting the aggregated actual recovery values based on the plurality of segment boundary definitions, wherein a first partition of the first plurality of partitions comprises a subset of the aggregated actual recovery values;
generate a first average recovery value comprising an average of the subset of the aggregated actual recovery values associated with the first partition;
generate a second plurality of partitions by sorting the plurality of actual recovery values based on the plurality of segment boundary definitions, wherein a second partition of the second plurality of partitions comprises a subset of the plurality of actual recovery values;
generate a second average recovery value comprising an average of the subset of the plurality of actual recovery values associated with the second partition;
generate comparison results by comparing the first average recovery value against the second average recovery value; and
transmit, to the first client system, a networked message comprising the comparison results.

26. The system of claim 25, wherein execution of the instructions further causes the one or more processors to:
receive, from the plurality of client systems, geographic information associated with each of the plurality of client systems; and
aggregate the one or more actual recovery values associated with each of the plurality of client systems based on the geographic information.

27. The system of claim 25, wherein execution of the instructions further causes the one or more processors to:
receive, from the plurality of client systems, demographic information associated with each of the plurality of client systems; and
aggregate the one or more actual recovery values associated with each of the plurality of client systems based on the demographic information.

28. The system of claim 21, wherein the historical data is associated with the second plurality of individuals, and wherein each individual of the second plurality of individuals is represented as a data point corresponding to a value for each variable in the hyperdimensional model.

29. The system of claim 21, wherein spline interpolation is performed within each dimension of the hyperdimensional model.

30. The system of claim 21, wherein execution of the instructions further causes the one or more processors to:
perform regression analysis on the hyperdimensional model to determine a relationship between the input data and the predicted recovery value; and
generate a formula based on the determined relationship.

31. The system of claim 21, wherein execution of the instructions further causes the one or more processors to:
in response to receiving an actual recovery value for an individual, update the hyperdimensional model based on the actual recovery value.

32. A method for automatic data segmentation, comprising:
receiving, from a client system, input data associated with a first individual of a first plurality of individuals for whom a client system has provided a service;
inputting, into a hyperdimensional model, the input data, wherein the hyperdimensional model is trained using historical data and a plurality of actual recovery values, wherein the historical data comprises one or more of: historical accounts receivable data, historical payment history data, and historical credit related data, and wherein a first actual recovery value of the plurality of actual recovery values corresponds to a second individual of a second plurality of individuals;
receiving, from the hyperdimensional model, output data comprising a predicted recovery value for the first individual, wherein the predicted recovery value is a weighted average of a predicted unit yield and a predicted recovery rate for the first individual,
receiving, from the client system, a plurality of segment boundary definitions that define a plurality of segments, where each of the plurality of segments correspond to a range of recovery values;
based on the predicted recovery value, assigning the first individual to a first segment of the plurality of segments, wherein the predicted recovery value is within the range of recovery values corresponding to the first segment; and
transmitting, to the client system, an electronic message comprising the first segment.

33. The method of claim 32, wherein the predicted unit yield comprises a total monetary amount predicted to be received from the first individual, and wherein the predicted recovery rate comprises a percentage of a total amount owed expected to be received from the first individual.

34. The method of claim 32, wherein the first actual recovery value comprises an actual unit yield and an actual recovery rate, wherein the actual unit yield comprises a total monetary amount received from the second individual, and wherein the actual recovery rate comprises a percentage of a total amount owed that was received from the second individual.

35. The method of claim 32, wherein the input data comprises one or more of:
accounts receivable data, payment history data, or payment history data.

36. The method of claim 32, the client system is a first client system of a plurality of client systems, and wherein the method further comprises:
aggregating one or more actual recovery values associated with each of the plurality of client systems;
generating a first plurality of partitions by sorting the aggregated actual recovery values based on the plurality of segment boundary definitions, wherein a first partition of the first plurality of partitions comprises a subset of the aggregated actual recovery values;
generating a first average recovery value comprising an average of the subset of the aggregated actual recovery values associated with the first partition;
generating a second plurality of partitions by sorting the plurality of actual recovery values based on the plurality of segment boundary definitions, wherein a second partition of the second plurality of partitions comprises a subset of the plurality of actual recovery values;
generating a second average recovery value comprising an average of the subset of the plurality of actual recovery values associated with the second partition;
generating comparison results by comparing the first average recovery value against the second average recovery value; and
transmitting, to the first client system, an electronic message comprising the first segment.

37. One or more non-transitory computer-readable media comprising computer-executable instructions, that, when executed, cause a system to:
receive, from a client system, input data associated with a first individual of a first plurality of individuals for whom a client system has provided a service;
input, into a hyperdimensional model, the input data, wherein the hyperdimensional model is trained using historical data and a plurality of actual recovery values, wherein the historical data comprises one or more of: historical accounts receivable data, historical payment history data, and historical credit related data, and wherein a first actual recovery value of the plurality of actual recovery values corresponds to a second individual of a second plurality of individuals;
receive, from the hyperdimensional model, output data comprising a predicted recovery value for the first individual, wherein the predicted recovery value is a weighted average of a predicted unit yield and a predicted recovery rate for the first individual,
receive, from the client system, a plurality of segment boundary definitions that define a plurality of segments, where each of the plurality of segments correspond to a range of recovery values;
based on the predicted recovery value, assign the first individual to a first segment of the plurality of segments, wherein the predicted recovery value is within the range of recovery values corresponding to the first segment; and
transmit, to the client system, an electronic message comprising the first segment.

38. The non-transitory computer-readable media of claim 37, wherein the predicted unit yield comprises a total monetary amount predicted to be received from the first individual, and wherein the predicted recovery rate comprises a percentage of a total amount owed expected to be received from the first individual.

39. The non-transitory computer-readable media of claim 37, wherein the first actual recovery value comprises an actual unit yield and an actual recovery rate, wherein the actual unit yield comprises a total monetary amount received from the second individual, and wherein the actual recovery rate comprises a percentage of a total amount owed that was received from the second individual.

40. The non-transitory computer-readable media of claim 37, wherein the input data comprises one or more of: accounts receivable data, payment history data, or payment history data.
